(19) United States
(12) Patent Application Publication
(10) Pub. No.: US 2013/0079189 A1
(43) Pub. Date: Mar. 28, 2013

(54) LOAD-SENSITIVE GEAR SHIFTING APPARATUS

(71) Applicants: Toshihiro Kobayashi, Nagoya-shi (JP); Mamoru Marutani, Kariya-shi (JP); Takeshi Hashizume, Handa-shi (JP)

(72) Inventors: Toshihiro Kobayashi, Nagoya-shi (JP); Mamoru Marutani, Kariya-shi (JP); Takeshi Hashizume, Handa-shi (JP)

(73) Assignee: AISIN SEIKI KABUSHIKI KAISHA, Kariya-shi (JP)

(21) Appl. No.: 13/701,771

(22) PCT Filed: Jun. 24, 2011
(86) PCT No.: PCT/JP2011/064561

§ 371 Date: Dec. 3, 2012

(30) Foreign Application Priority Data
Jul. 1, 2010 (JP) 2010-151186
Sep. 29, 2010 (JP) 2010-218913

(51) Int. Cl. F16H 3/44

(52) U.S. Cl. CPC F16H 3/44
USPC 475/282

(57) ABSTRACT

A gear shifting apparatus that automatically performs gear shifting in response to a load is constituted by a small number of components. The gear shifting apparatus includes an output shaft coupled to a carrier of a planetary gear shifting mechanism, an operating ring that rotates relative to a ring gear of the planetary gear shifting mechanism, and a coil spring that biases the ring gear and the operating ring so as to maintain their relative rotational orientations in neutral orientations. The apparatus further includes an operating member that couples the ring gear and the carrier to each other when the relative rotational orientations of the ring gear and the operating ring are the neutral orientations, and fixes the ring gear and allows rotation of the carrier when the relative rotational orientations come off the neutral orientations.

### TECHNICAL FIELD

The present invention relates to a load-sensitive gear shifting apparatus, and particularly relates to a gear shifting apparatus in which gear shifting is performed by a mechanical operation in accordance with a change in a load acting on an output system.

### BACKGROUND ART

As an example of a load-sensitive gear shifting apparatus having a configuration as described above, PTL 1 discloses a chain block that transmits an operating force on a hand chain wheel to a load sheave, and in this chain block, when a lifting operation under no load is performed by operating the hand chain wheel, a chain is wound at a high speed, and when a lifting operation is performed under a load, the chain is wound at a low speed.

According to a specific form of operation of PTL 1, when the lifting operation is performed under no load, a transmission plate, a clutch plate, and the like are moved in an axial direction of a driving shaft by a rotating force of the hand chain wheel, and thus the rotating force of the hand chain wheel is transmitted to a carrier (“gear holding plate” in the document) of a planetary gear (the function of a first clutch means). Since a ring gear (“fixed gear” in the document) of the planetary gear is fixed, and a sun gear (“output shaft” in the document) is splined to the driving shaft, the rotating force of the carrier is transmitted to the driving shaft with the speed increased, and consequently rotates the load sheave at a high speed.

Conversely, in a state in which a load acts on the load sheave, when the lifting operation on the hand chain wheel is also performed, the effect of the force from the load sheave and the force from the hand chain wheel causes the transmission plate, the clutch plate, and the like to move in a reverse direction (the reverse direction when compared to the moving direction under no load), so that power transmission to the planetary gear is cut off, and the rotating force of the hand chain wheel is transmitted to the driving shaft due to pressured contact of a brake plate and the like (the function of a second clutch means), and consequently rotates the load sheave at a low speed.

### CITATION LIST

### Patent Literature

PTL 1: JP 2001-146391A

### SUMMARY OF INVENTION

The apparatus disclosed in Patent Document 1 has an advantage that even though the apparatus does not include sensors, actuators, and the like for realizing electrical control, a gear shifting operation is automatically performed in response to a change in the load.

However, those including two types of clutch means and using the planetary gear mechanism only when increasing the speed as disclosed in Patent Document 1 have a large number of components, so that their transmission systems also tend to be complicated, and there is a room for improvement.

It is an object of the present invention to provide a gear shifting apparatus constituted by a small number of components, the gear shifting apparatus performing automatic gear shifting in response to a load.

A feature of the present invention is that a gear shifting apparatus includes a planetary gear transmission system constituted by a sun gear, a ring gear that surrounds the sun gear, a planet gear that interlocks with the sun gear and the ring gear, a carrier that can revolve together with the planet gear, and an output system that extracts the revolving motion of the carrier; a load obtaining means that extracts the amount of a load acting on the output system as the amount of mechanical operation; and a switching means that integrally rotates the sun gear, the ring gear, the planet gear, and the carrier if the load obtained by the load obtaining means is less than a set value, and allows rotation of the carrier while inhibiting rotation of any gear of the sun gear and the ring gear that is not a gear to which a driving force is input if the load obtained by the load obtaining means exceeds the set value.

With this configuration, if the load obtained by the load obtaining means is less than a set value, the switching means integrally rotates the sun gear, the ring gear, the planet gear, and the carrier, thereby realizing a high-speed transmission state. Moreover, if the load obtained by the load obtaining means exceeds the set value, the switching means allows rotation of the carrier while inhibiting rotation of any gear of the sun gear and the ring gear that is not a gear to which the driving force is input, thereby realizing a low-speed transmission state.

That is to say, when compared to an apparatus including, as disclosed in Patent Document 1, two types of transmission systems, that is, a transmission system that realizes a high-speed transmission state and a transmission system that realizes a low-speed transmission state, and two types of clutch means for selecting these two types of transmission systems, the transmission system of the present invention is simplified. Moreover, with the configuration of the present invention, when switching between the high-speed transmission state and the low-speed transmission state is performed, the switching means controls the functions of a part of the constitutional elements of the planetary gear transmission mechanism, and therefore in both the high-speed transmission state and the low-speed transmission state, the driving force is transmitted to the output system via the planetary gear transmission system, so that an increase in the size of the transmission system is suppressed.

In particular, in a planetary gear mechanism, two types of forms of transmission for realizing a speed reduction are conceivable. One of these is a form in which, in a state in which the ring gear is fixed, the driving force input to the sun gear is output from the carrier. The other is a form in which, in a state in which the sun gear is fixed, the driving force input to the ring gear is output from the carrier. For this reason, a speed-reduced state is realized by inhibiting rotation of any gear of the sun gear and the ring gear that is not a gear to which the driving force is input.

As a result, a gear shifting apparatus that performs automatic gear shifting in response to a load can be constituted by a small number of components.

According to the present invention, it is also possible that the gear shifting apparatus includes an input shaft that serves as an input system and transmits the driving force to the sun gear, and an output shaft that serves as the output system and is coupled to the carrier, wherein the load obtaining means includes an operating ring that is supported coaxially with an axis of the ring gear so as to be rotatable relative to the ring gear, a biasing member that biases the operating ring and the ring gear so as to maintain their relative rotational orientations in neutral orientations, and an operating member that is linked with the carrier and the ring gear so as to change in orientation in accordance with a load acting on the carrier, the operating member being configured so as to be in a high-speed transmission orientation when the relative rotational orientations of the carrier and the ring gear are the neutral orientations, and reach a low-speed transmission orientation when the relative rotational orientations come off the neutral orientations.

As a result of the load obtaining means including the operating ring, the biasing member, and the operating member as in this configuration, if the load acting on the output shaft is less than a set value, the biasing force of the biasing member acts and maintains the relative rotational orientations of the operating ring and the ring gear in the neutral orientations, and the operating member is in the high-speed transmission orientation. Moreover, conversely, if the load acting on the output shaft exceeds the set value, the relative rotational orientations of the operating ring and the ring gear come off the neutral orientations against the biasing force of the biasing member, and the operating member reaches the low-speed transmission orientation.

According to the present invention, it is also possible that the switching means is constituted by the operating member, an engagement portion that engages with the operating member to combine the operating member with the carrier when the operating member is in the high-speed transmission orientation, and a lock portion that comes into contact with the operating member to inhibit rotation of the ring gear when the operating member is in the low-speed transmission orientation.

As a result of the switching means including the operating member, the engagement portion, and the lock portion as in this configuration, when the operating member is in the high-speed transmission orientation, the operating member is in engagement with the engagement portion of the carrier, so that the ring gear and the carrier are combined with each other, and consequently a high-speed transmission state is realized in which the transmission system from the sun gear to the output shaft is integrally rotated. Moreover, conversely, when the operating member is in the low-speed transmission orientation, the operating member is disengaged from the engagement portion of the carrier, so that it is possible to cause the operating member to newly come into contact with the lock portion of a fixing system. Thus, the carrier can rotate, with the ring gear inhibited from rotating, and a low-speed transmission state is realized in which the speed is reduced by the planetary gear transmission system.

According to the present invention, it is also possible that the operating member is supported by the ring gear so as to be swingable on a pivotal support shaft extending parallel to the input shaft and the output shaft, and includes an engagement piece that engages with the engagement portion and a contact piece that comes into contact with the lock portion, a plurality of engagement portions each of which is the above engagement portion is formed like a gear around the axis of the carrier, and a plurality of lock portions each of which is the above lock portion is formed on an inner surface of a gear case serving as a fixing system, like an external gear or an internal gear around the axis of the carrier.

With this configuration, when the relative rotational orientations of the operating ring and the ring gear are the neutral orientations, the engagement piece of the operating member, which is in the high-speed transmission orientation, can be engaged with any of the plurality of engagement portions formed in the carrier like an external gear. Moreover, when the relative rotational orientations of the operating ring and the ring gear come off the neutral orientations, the contact piece of the operating member, which is in the low-speed transmission orientation, can come into contact with the plurality of lock portions formed in the fixing system.

According to the present invention, it is also possible that a circular arc-shaped long hole around the input shaft is formed in the operating ring so that the pivotal support shaft passes therethrough, a link shaft extending parallel to the input shaft passes through a long hole that is formed in the operating member, and the link shaft is coupled to the operating ring.

With this configuration, if the rotational orientations of the operating ring and the ring gear change, the position of the pivotal support shaft within the circular arc-shaped long hole formed in the operating ring moves, and with this movement of the position of the pivotal support shaft, the position of the link shaft within the long hole formed in the operating member moves. As a result, the positional relationship between the pivotal support shaft and the link shaft can be changed relative to each other, and the operating member can swing on the pivotal support shaft. Thus, the orientation of the operating member can be smoothly changed.

According to the present invention, it is also possible that the operating member is configured so that when the contact piece comes into contact with the lock portion, the contact piece can elastically deform under a reaction force from the lock portion in a state in which the contact piece has mounted on the gear-like portion.

With the above-described operating member, during shifting from a contact state in which it is in contact with the engagement portion to a contact state in which it is in contact with the lock portion, a so-called “idling” state may occur in which the operating member is in contact with neither the engagement portion nor the lock portion. For this reason, for the operating member, it is necessary to set a lap for connection in which while the engagement piece is still in contact with the engagement portion, the contact piece also comes into contact with the lock portion.

At this time, if the operating member is composed of a rigid body, when switching from high speed to low speed is performed, respective forces of the contact state in which the engagement piece of the operating member is in contact with the engagement portion and the contact state in which the contact piece of the operating member is in contact with the lock portion are evenly matched, creating a so-called “deadlock”, and thus there is a possible that switching for gear shifting cannot by properly performed.

As in the case of the present configuration, when the operating member is configured so that when the contact piece comes into contact with the lock portion, the contact piece can elastically deform under the reaction force from the lock portion in a state in which the contact piece has mounted on the gear-like portion, even if the respective forces of the contact state in which the engagement piece of the operating member is in contact with the engagement portion and the contact state in which the contact piece of the operating member is in contact with the lock portion are evenly matched, the contact piece of the operating member elastically deforms and moves backward under the reaction force from the lock portion in the state in which the contact piece has mounted on the gear-like portion. On the other hand, the engagement piece of the operating member is allowed to rotate in a direction in which it is disengaged from the engagement portion within a distance corresponding to the backward movement of the contact piece. Thus, the operating member in the contact state in which it is in contact with the engagement portion is disengaged from the engagement portion, and after that, the operating member meshes with the lock portion. As a result, it is possible to avoid a problem in that the operating member is deadlocked between the engagement portion and the lock portion.

According to the present invention, it is also possible that the operating member includes a main body portion and a deforming portion that is connected to the main body portion and the contact piece, and is configured so that when the contact piece comes into contact with the lock portion, the deforming portion can elastically deform under the reaction force from the lock portion in a state in which the contact piece has mounted on the gear-like portion.

As in this configuration, when the operating member includes the main body portion and the deforming portion that is connected to the main body portion and the contact piece, and is configured so that when the contact piece comes into contact with the lock portion, the deforming portion can elastically deform under the reaction force from the lock portion in the state in which the contact piece has mounted on the gear-like portion, in the state in which the contact piece of the operating member under the reaction force from the lock portion has mounted on the gear-like portion, the deforming portion of the operating member elastically deforms and moves backward. On the other hand, the engagement piece of the operating member is allowed to rotate in a direction in which it is disengaged from the engagement portion within a distance corresponding to the backward movement of the contact piece. Thus, the operating member in the contact state in which it is in contact with the engagement portion is disengaged from the engagement portion, and after that, the operating member meshes with the lock portion. As a result, it is possible to avoid a problem in that the operating member is deadlocked between the engagement portion and the lock portion.

Moreover, since the contact piece is provided at a distance from the main body portion, the contact piece under the reaction force from the lock portion can move backward without being obstructed by the main body portion, so that the engagement piece of the operating member is also allowed to more smoothly rotate in the direction in which it is disengaged from the engagement portion. Moreover, the operating member is required to include only in a portion thereof the deforming portion that is elastically deformable (deforms when a load is applied and returns to an original shape when the load is no longer applied). Therefore, the manufacturing cost of the operating member can be reduced, and the strength of the operating member itself can be maintained by increasing the rigidity of a portion other than the deforming portion.

According to the present invention, it is also possible that in the operating member, the deforming portion on an outer circumferential side extends from the vicinity of the pivotal support shaft toward either end of the operating member and is partially separated from the main body portion on an inner circumferential side, and the deforming portion is connected to the main body portion and the contact piece by providing the contact piece at an end portion of the deforming portion.

With this configuration, as a result of the deforming portion being located in an outer circumferential portion of the main body portion, a sufficient length of the deforming portion can be secured, so that the deforming portion can be easily elastically deformed.

According to the present invention, it is also possible that the contact piece is L-shaped so as to cover the main body portion at a distance from an end portion of the main body portion, and includes an end edge portion serving as an end portion of the operating member and an inner edge portion extending from the end edge portion toward the main body portion, and a protruding touching portion that can touch the end edge portion is formed in an end portion of the main body portion.

With this configuration, the contact piece includes the end edge portion serving as the end portion of the operating member and the inner edge portion extending from the end edge portion toward the end portion of the main body portion, and is L-shaped so as to cover the main body portion at a distance from the end portion of the main body portion, and therefore due to the end edge portion and the inner edge portion, the contact piece can accept both the reaction force from the lock portion in the state in which the contact piece is in contact with both the engagement portion and the lock portion and the reaction force from the lock portion in the low-speed transmission state. Moreover, as a result of the protruding touching portion being provided in the end portion of the main body portion, the deforming portion is allowed to elastically deform until the contact piece touches the protruding touching portion, and does no longer elastically deform after the contact piece has touched the protruding touching portion. Consequently, excessive deformation of the deforming portion can be easily prevented, and the durability of the operating member can be improved.

According to the present invention, it is also possible that the gear shifting apparatus includes an input shaft that serves as an input system and transmits the driving force to the sun gear, and an output shaft that serves as the output system and is coaxial with an axis on which the carrier revolves, wherein the load obtaining means is constituted by a cam ring that can transmits a torque to the output shaft and can move along an axis of the output shaft, cam portions that are respectively formed in opposing surfaces of the cam ring and the carrier, and a biasing member that biases the cam ring toward the carrier, and is configured so that if a load acting on the output shaft is less than a set value, the cam ring is in a reference position, and if the load acting on the output shaft exceeds the set value, the cam ring reaches a shift position at a distance from the carrier, and the switching means is constituted by a shift ring that is, while maintaining a contact state in which the shift ring is in contact with the ring gear, located in a high-speed transmission position when the cam ring is in the reference position, and located in a low-speed transmission position when the cam ring is in the shift position, the shift ring including a first contact portion that comes into contact with the carrier, thereby integrally rotating the ring gear and the carrier, when the shift ring is in the high-speed transmission position, and a second contact portion that comes into contact with a fixing system, thereby inhibiting rotation of the ring gear, when the shift ring is in the low-speed transmission position.

With this configuration, if the load acting on the output shaft is less than a set value, the operating ring is in the reference position, so that the first contact portion of the shift ring comes into contact with the carrier, thereby integrally rotating the ring gear and the carrier and realizing a high-speed transmission state. Conversely, if the load acting on the output shaft exceeds the set value, it is possible to separate the first contact portion of the shift ring from the carrier and cause the second contact portion of the shift ring to newly come into contact with the fixing system, and thus a low-speed transmission state is realized by the planetary gear transmission system.

According to the present invention, it is also possible that when the shift ring is in the high-speed transmission position, a third contact portion that is provided at an outer end of the shift ring comes into contact with and is combined with the ring gear, and the first contact portion of the shift ring comes into contact with the carrier, and thus a high-speed transmission state is realized in which the planetary gear transmission system is integrally rotated and the input shaft and the output shaft are rotated at the same rotation speed.

According to the present invention, it is also possible that when the shift ring is in the low-speed transmission position, while a state in which the third contact portion that is provided at the outer end of the shift ring is in contact with the ring gear is maintained, the first contact portion of the shift ring is spaced apart from the carrier, and the second contact portion of the shift ring newly comes into contact with a transmission case and locks rotation of the ring gear, and thus a low-speed transmission state is realized in which rotation of the carrier is allowed.

### BRIEF DESCRIPTION OF DRAWINGS

FIG. 1 is a vertical cross-sectional side view of a load-sensitive gear shifting apparatus in a high-speed transmission state.

FIG. 2 is a vertical cross-sectional side view of the load-sensitive gear shifting apparatus in a low-speed transmission state.

FIG. 3 is a cross-sectional view taken along line III-III in FIG. 1.

FIG. 4 is a cross-sectional view taken along line IV-IV in FIG. 1.

FIG. 5 is a cross-sectional view taken along line V-V in FIG. 2.

FIG. 6 is a cross-sectional view taken along line VI-VI in FIG. 2.

FIG. 7 is an exploded perspective view of the load-sensitive gear shifting apparatus.

FIG. 8 is a cross-sectional view showing a high-speed transmission state of another embodiment (a).

FIG. 9 is a diagram showing an operating member according to the embodiment (a).

FIG. 10A is a partial cross-sectional view showing the high-speed transmission state of the embodiment (a).

FIG. 10B is a partial cross-sectional view showing a state in the midst of shifting from the high-speed transmission state to a low-speed transmission state of the embodiment (a).

FIG. 10C is a partial cross-sectional view showing a state in the midst of shifting from the high-speed transmission state to the low-speed transmission state of the embodiment (a).

FIG. 10D is a partial cross-sectional view showing the low-speed transmission state of the embodiment (a).

FIG. 11 shows another embodiment (c), in which FIG. 11(a) shows a high-speed transmission state, and FIG. 11(b) shows a low-speed transmission state.

### DESCRIPTION OF EMBODIMENTS

Hereinafter, embodiments of the present invention will be described based on the drawings.

### [Basic Configuration]

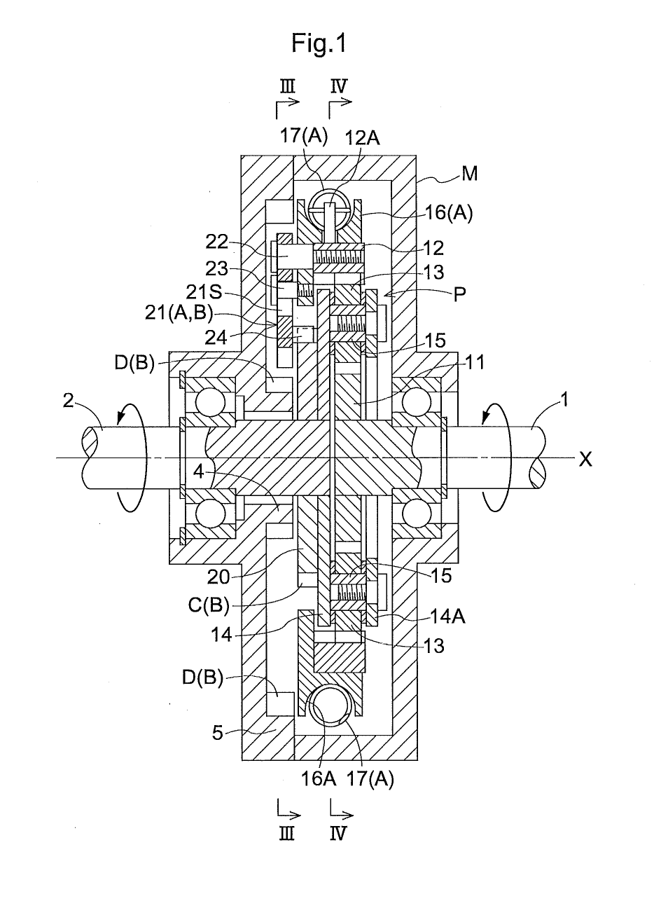

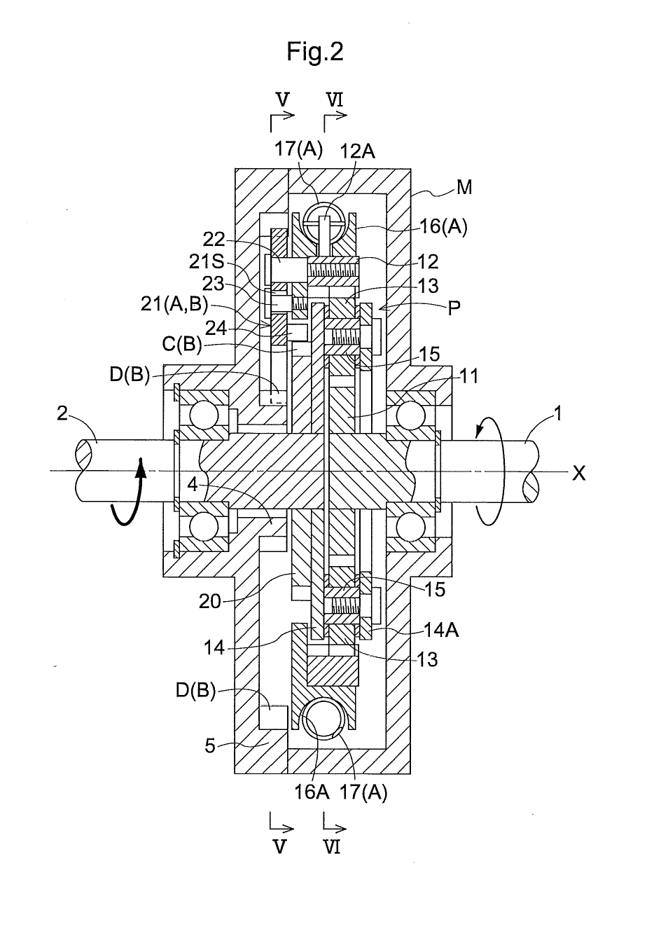

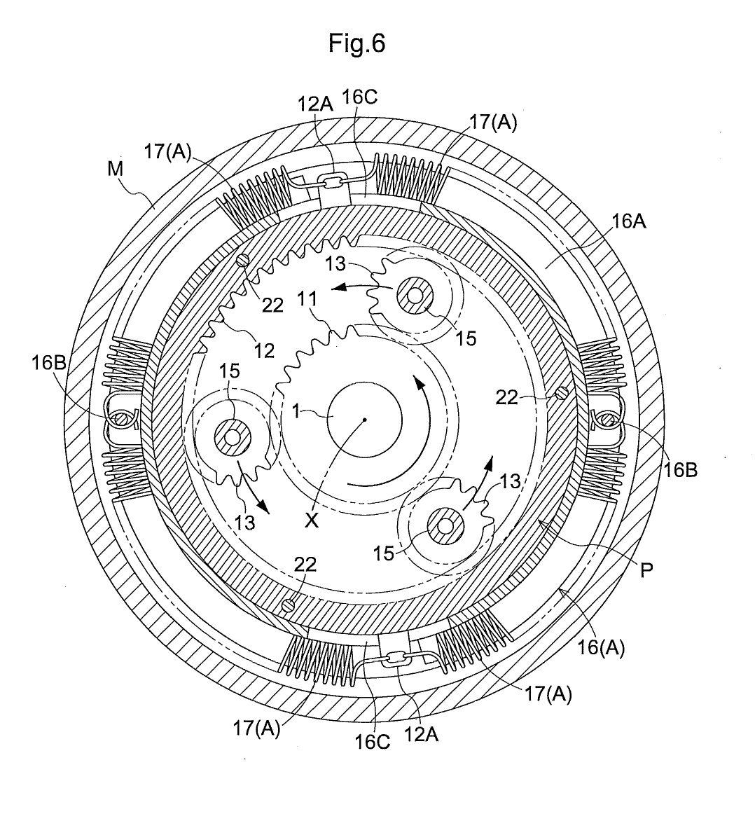

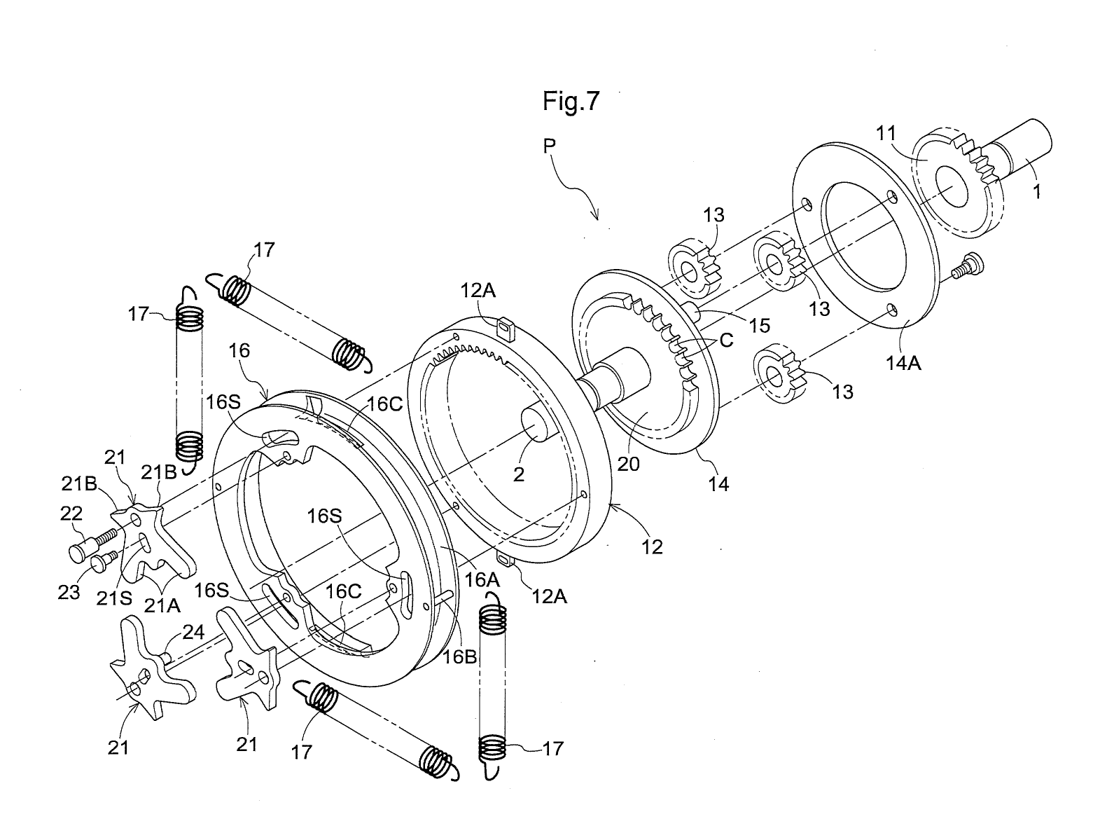

As shown in FIGS. 1, 3, 4, and 7, a load-sensitive gear shifting apparatus of the present invention includes a transmission case M provided with an input shaft 1 serving as an input system and an output shaft 2 serving as an output system, and includes a planetary gear shifting mechanism P (an example of a planetary gear transmission system) within this transmission case M. If a load acting on the output shaft 2 is less than a set value, this load-sensitive gear shifting apparatus drives the output shaft 2 in a high-speed transmission state in which the output shaft 2 is driven at a speed equal to the rotation speed of the input shaft 1 as shown in FIGS. 1, 3, and 4. Moreover, if the load acting on the output shaft 2 exceeds the set value, the load-sensitive gear shifting apparatus drives the output shaft 2 in a low-speed transmission state in which the output shaft 2 is driven at a lower speed than the rotation speed of the input shaft 1 by reducing the speed in the planetary gear shifting mechanism P as shown in FIGS. 2, 5, and 6.

In particular, in this load-sensitive gear shifting apparatus, in any situation in which the input shaft 1 rotates in either the forward or the reverse rotation direction, switching between the high-speed transmission state and the low-speed transmission state is realized in response to the load acting on the output shaft 2.

This load-sensitive gear shifting apparatus is provided in a drive source or the like for an object to be driven, such as a sliding door used in an automobile that applies a light load in the midst of an operation range and an increased load when it is closed, and suppresses an increase in the size of an electric motor because the gear ratio is changed in accordance with the load. Moreover, with regard to the object to be operated, the load-sensitive gear shifting apparatus can be used in all parts of an automobile, such as a driving system that adjusts the seat back angle and a driving system that opens/closes the door glass, but in addition, the load-sensitive gear shifting apparatus can be used in applications other than automobiles.

The planetary gear shifting mechanism P includes a sun gear 11 that is coupled to the input shaft 1, a ring gear 12 that is disposed in a position surrounding the sun gear 11, three planet gears 13 that interlock with the sun gear 11 and the ring gear 12, and a carrier 14 that can revolve together with the plurality of planet gears 13. The carrier 14 is coupled to the output shaft 2 that extracts the revolving motion, and includes three freely rotating shafts 15 that respectively support the three planet gears 13 so as to allow free rotation and a carrier ring 14A that is coupled to respective end portions of the three freely rotating shafts 15.

As shown in FIGS. 1 and 2, the input shaft 1 and the output shaft 2 are arranged coaxially with a main axis X. Accordingly, the axis of the sun gear 11, the axis of the ring gear 12 (the axis at the center of the ring), and the axis of revolution of the carrier 14 are arranged coaxially with the main axis X.

### [Load Sensing Structure]

The load-sensitive gear shifting apparatus includes a load obtaining means A and a switching means B. The load obtaining means A extracts the amount of load acting on the output shaft 2 (the output system) as the amount of mechanical operation. If the load obtained by the load obtaining means A is less than a set value, the switching means B realizes a high-speed transmission state in which the sun gear 11, the ring gear 12, the planet gears 13, and the carrier 14 are integrally rotated. Moreover, if the load obtained by the load obtaining means A exceeds the set value, the switching means B realizes a low-speed transmission state in which rotation of the carrier 14 is allowed while rotation of the ring gear 12 is inhibited.

An operating ring 16 is provided which is externally fitted to the ring gear 12 so as to be rotatable on the main axis X, and a plurality of coil springs 17 is provided which serves as a biasing means maintaining the operating ring 16 and the ring gear 12 in predetermined relative rotational orientations around the main axis X. The load obtaining means A is constituted by the operating ring 16, the plurality of coil springs 17, and operating members 21. The operating members 21 are linked with the carrier 14 and the ring gear 12 so that their orientations change in accordance with a load acting on the carrier 14. Details of this linkage and the like will be described later.

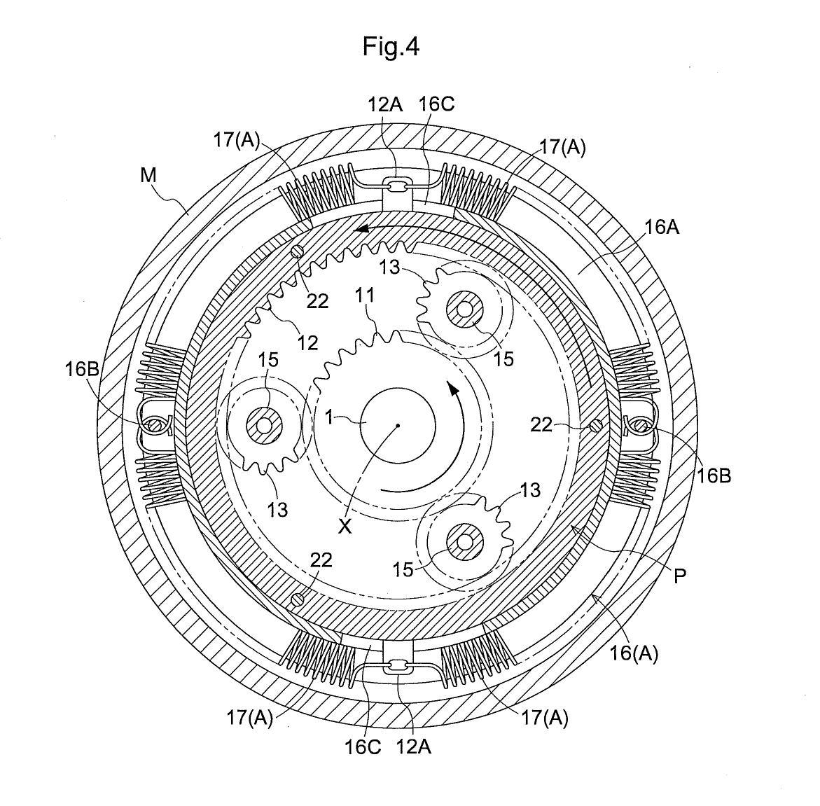

A groove-like spring accommodation space 16A is formed in an outer circumference of the operating ring 16, a pair of spring locking portions 16B are formed in this spring accommodation space 16A, and a pair of insertion openings 16C are formed in an inner circumference of the operating ring 16. A pair of projecting tabs 12A that are inserted in the respective insertion openings 16C are provided so as to project outward from an outer circumference of the ring gear 12. Moreover, the coil springs 17 are provided between each of the projecting tabs 12A, which are inserted in the respective insertion openings 16C, and the spring locking portions 16B, and thus the coil springs 17 apply a biasing force that maintains the operating ring 16 and the ring gear 12 in neutral orientations shown in FIG. 4 around the main axis X.

An engagement plate 20 having a shape that surrounds the output shaft 2 is fixed to a surface of the carrier 14, and a plurality of engagement portions C is formed along an outer circumferential portion of the engagement plate 20 like an external gear around the main axis X. A block portion 4 having a shape that surrounds the output shaft 2 is formed in an inner surface of the transmission case M serving as a fixing system, and a plurality of lock portions D is formed along an outer circumference of this block portion 4 like an external gear around the main axis X. Moreover, a ring portion 5 extending along the operating ring 16 is formed in the inner surface of the transmission case M, and a plurality of lock portions D is formed along an inner circumference of this ring portion 5 like an internal gear around the main axis X.

The aforementioned three operating members 21 are provided so as to change their swing orientations on respective pivotal support shafts 22 in accordance with a change in the relative rotational orientations of the operating ring 16 and the ring gear 12 and selectively switch between a state in which the operating members 21 engage with the respective engagement portions C and a state in which the operating members 21 come into contact with the respective lock portions D, by changing the swing orientations.

In the load-sensitive gear shifting apparatus of the present invention, the load obtaining means A is constituted by the operating ring 16, the coil springs 17, and the operating members 21.

The operating members 21 are supported by the ring gear 12 so as to be swingable on the respective pivotal support shafts 22 extending parallel to the main axis X. Circular arc-shaped long holes 16S around the main axis X are formed in the operating ring 16 so that the respective pivotal support shafts 22 pass therethrough. Moreover, link shafts 23 extending parallel to the main axis X pass through respective long holes 21S formed in the operating members 21, and the link shafts 23 are coupled to the operating ring 16.

A screw portion is formed at an end portion of each pivotal support shaft 22, and this screw portion is screwed into a screw hole of the ring gear 12, thereby allowing the pivotal support shaft 22 to be supported by the ring gear 12. Similarly, a screw portion is formed at an end portion of each link shaft 23, and this screw portion is screwed into a screw hole of the operating ring 16, thereby allowing the link shaft 23 to be coupled to the operating ring 16. When the rotational orientations of the operating ring 16 and the ring gear 12 around the main axis X have changed, the position of the pivotal support shaft 22 in each circular arc-shaped long hole 16S formed in the operating ring 16 moves, and the position of the link shaft 23 in the long hole 21S formed in the corresponding operating member 21 changes with the movement of the position of the pivotal support shaft 22. As a result, the positional relationship between the pivotal support shaft 22 and the link shaft 23 can be changed relative to each other, allowing the operating member 21 to swing on the pivotal support shaft 22. Thus, the orientations of the operating members 21 can be smoothly changed.

The operating members 21 are formed of a plate-like material, and each have an engagement pin 24 (an example of an engagement piece) that engages with the above-described engagement portions C, a pair of internal contact pieces 21A that come into contact with the above-described lock portions D in the form of external teeth, and a pair of external contact pieces 21B that come into contact with the above-described lock portions D in the form of internal teeth.

In the load-sensitive gear shifting apparatus of the present invention, the switching means B is constituted by the operating members 21, the engagement portions C formed in the engagement plate 20, the lock portions D formed in the block portion 4, and the lock portions D formed in the ring portion 5. That is to say, the operating members 21 are included in both of the load obtaining means A and the switching means B, and a reduction in the number of components is realized by sharing the operating members 21 in this manner.

In particular, in this embodiment, a configuration may also be adopted in which the lock portions D are formed in either one of the block portion 4 and the ring portion 5. In cases where the lock portions D are formed in only one of these portions as described above, it is sufficient that only the internal contact pieces 21A or the external contact pieces 21B of the operating members 21 are formed.

### [Form of Operation]

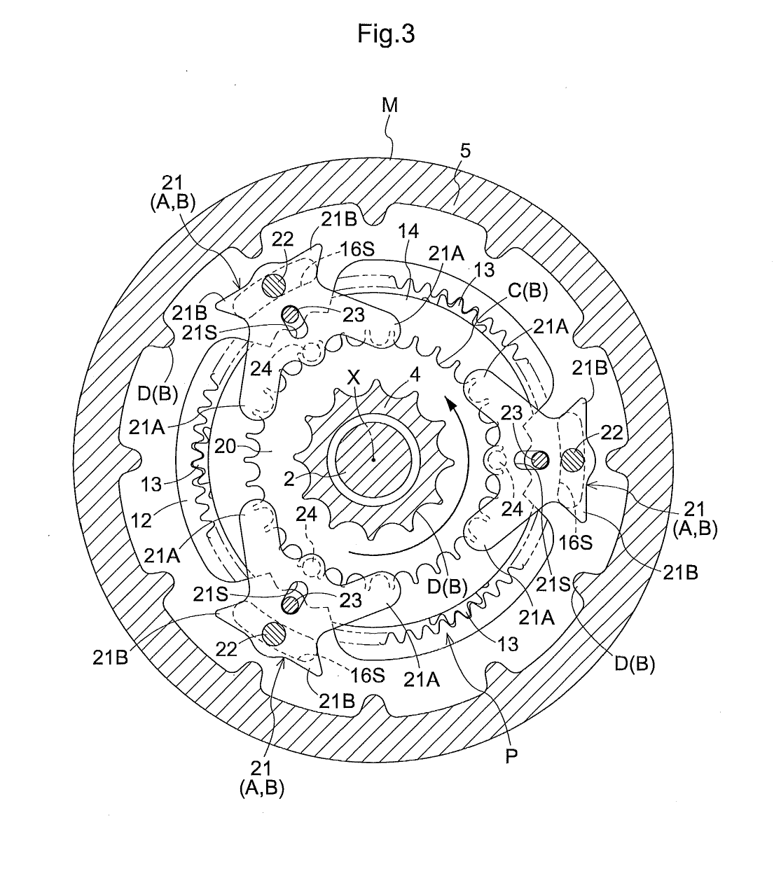

Due to the above-described configuration, if the load acting on the output shaft 2 is less than a set value, the biasing force of the coil springs 17 maintains relative rotational orientations of the operating ring 16 and the ring gear 12 in neutral orientations shown in FIG. 4, and in accordance with this, the three operating members 21 are maintained in high-speed transmission orientations shown in FIG. 3.

In the high-speed transmission orientations, the engagement pin 24 of each operating member 21 is engaged with any of the plurality of engagement portions C formed along the outer circumference of the engagement plate 20. Thus, the ring gear 12 and the carrier 14 are combined with each other, and consequently a high-speed transmission state is realized in which the sun gear 11, the ring gear 12, the planet gears 13, and the carrier 14 are integrally rotated.

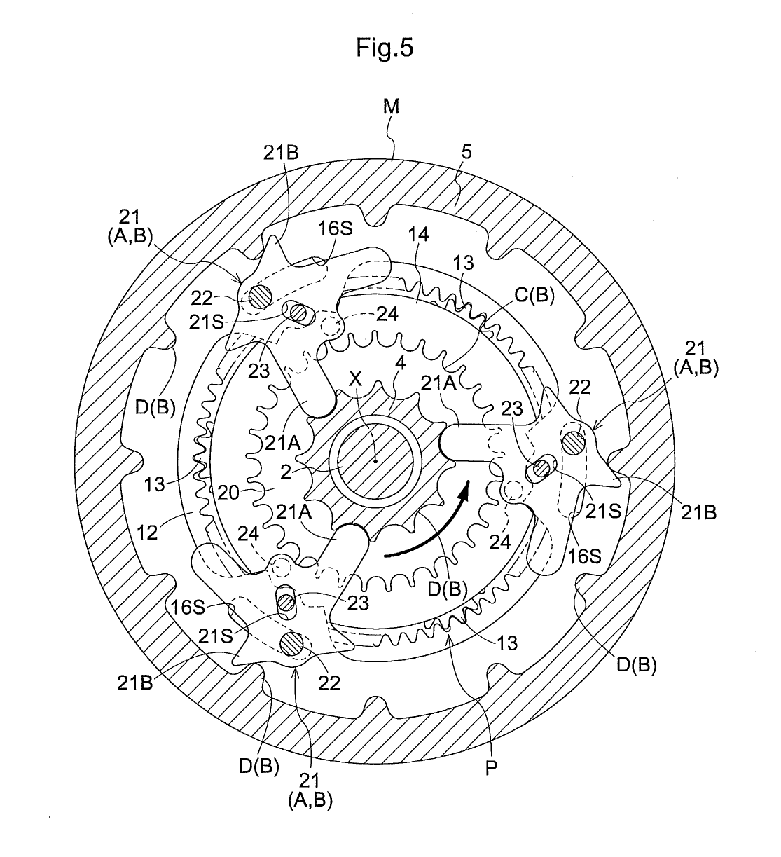

Conversely, if the load acting on the output shaft 2 exceeds the set value, the relative rotational orientations of the operating ring 16 and the ring gear 12 come off the neutral orientations shown in FIG. 4 against the biasing force of the coil springs 17, and in accordance with this, the three operating members 21 are set in low-speed transmission orientations shown in FIG. 5.

When the operating members 21 switch from the high-speed transmission orientations to the low-speed transmission orientations, the engagement pin 24 of each operating member 21 is separated from the engagement portion C of the engagement plate 20. At the same time, a state is reached in which an internal contact piece 21A of the operating member 21 newly comes into contact with a lock portion D of the block portion 4 and an external contact piece 21B of the operating member 21 newly comes into contact with a lock portion D of the ring portion 5. Thus, the ring gear 12 is locked by the transmission case M, and a low-speed transmission state is realized in which rotation of the ring gear 12 is inhibited and rotation of the carrier 14 is allowed.

In particular, in order to ensure that the orientation of the operating member 21 is reliably switched, the operation timing is set so that immediately before the engagement pin 24 of the operating member 21 is completely separated from the engagement portion C of the engagement plate 20, the internal contact piece 21A of the operating member 21 comes into contact with the lock portion D of the block portion 4 and the external contact piece 21B of the operating member 21 comes into contact with the lock portion D of the ring portion 5. As a result of setting the operation timing in this manner, when the orientation of the operating member 21 is switched, in the course of switching of the orientations, a state is reached in which the internal contact piece 21A and the external contact piece 21B come into contact with the respective lock portions D while the engagement pin 24 is being separated from the engagement portion C.

Then, in this low-speed transmission state, if the load acting on the output shaft 2 decreases, the biasing force of the coil springs 17 returns the relative rotational orientations of the operating ring 16 and the ring gear 12 to the neutral orientations (see FIG. 4). When returning to the neutral orientations, the internal contact pieces 21A and the external contact pieces 21B of the three operating members 21 are spaced apart from the lock portions D. At the same time, a state is reached in which the engagement pin 24 of each operating member 21 is engaged with any of the engagement portions C along the outer circumference of the engagement plate 20.

Also when the operating members 21 switch their orientations in this manner, in order to ensure that the switching is reliably performed, the operation timing is set so that immediately before the internal contact pieces 21A and the external contact pieces 21B of the operating members 21 are completely spaced apart from the lock portions D, the engagement pins 24 of the operating members 21 begin engaging with the plurality of engagement portions C along the outer circumference of the engagement plate 20.

### Effects of Embodiment

As described above, in the load-sensitive gear shifting apparatus, a load acting on the output shaft 2 is obtained by the load obtaining means A as the amount of mechanical operation. Then, if this load is less than a set value, the switching means B couples the ring gear 12 and the carrier 14 to each other, thereby creating the state in which the planetary gear shifting mechanism P is integrally rotated and realizing a high-speed transmission state. Moreover, if the load exceeds the set value, the switching means B allows rotation of the carrier 14 while inhibiting rotation of the ring gear 12, thereby causing the planetary gear shifting mechanism P to reduce the speed and realizing a low-speed transmission state.

That is to say, even though the load-sensitive gear shifting apparatus of the present invention does not include sensors and actuators for performing electrical control, the load-sensitive gear shifting apparatus realizes switching between the high-speed transmission state and the low-speed transmission state by obtaining the load acting on the output shaft 2 as the amount of mechanical operation, and the switching means performing switching according to this operation.

In particular, since the operating members 21 are included in both of the load obtaining means A and the switching means B, a reduction in the number of components is realized when compared to those equipped with a plurality of clutches. In addition, since a transmission system is configured so that the power is transmitted to the planetary gear shifting mechanism P in both the high-speed transmission state and the low-speed transmission state, a reduction in the size of the transmission system is realized when compared to, for example, those equipped with a plurality of transmission systems and clutches and the like for selecting the plurality of transmission systems.

### Another Embodiment (a)

In addition to the above-described embodiment, the load-sensitive gear shifting apparatus of the present invention may also have a configuration described below (in this other embodiment, those having the same functions as in the above embodiment are denoted by the same reference numerals or symbols as in the above embodiment).

As described above, in order to ensure that the operating members 21 reliably switch their orientations, the operation timing is set so that immediately before the operating members 21 are completely separated from the engagement portions C of the engagement plate 20, a contact piece 21A of each operating member 21 comes into contact with a lock portion D of the block portion 4. At this time, if the entire operating member 21 is composed of a rigid body, respective forces of the contact state in which the operating member 21 is in contact with the engagement portion C and the contact state in which the operating member 21 is in contact with the lock portion D are evenly matched, creating a so-called “deadlock”, and thus there is a possibility that switching for gear shifting cannot be properly performed.

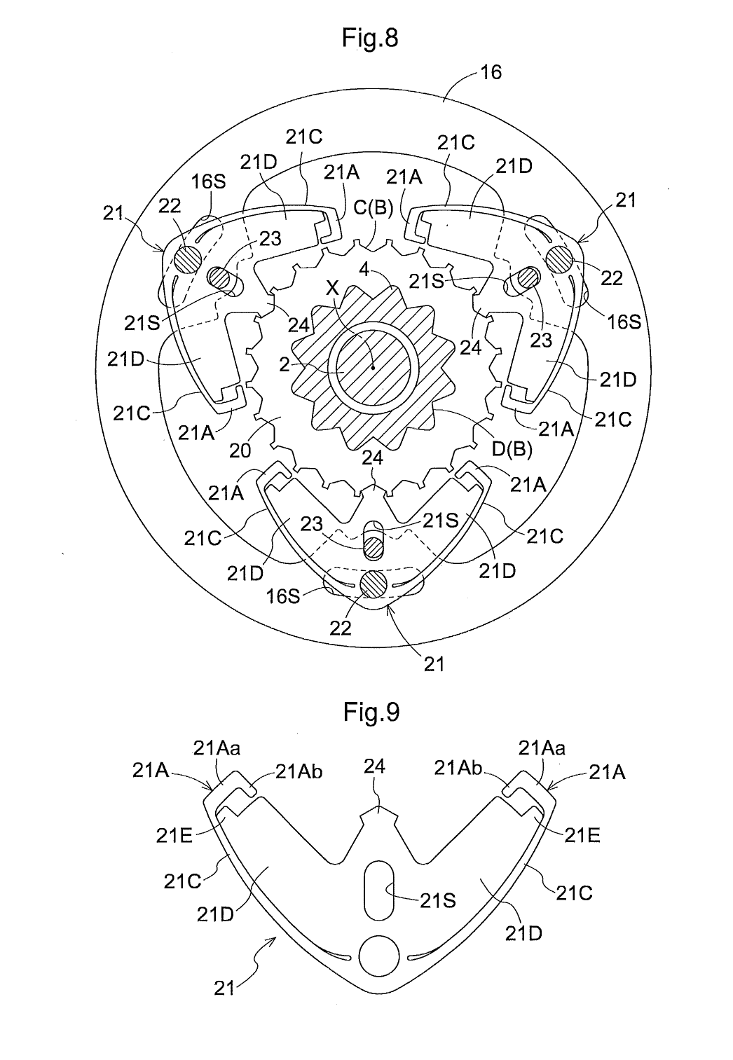

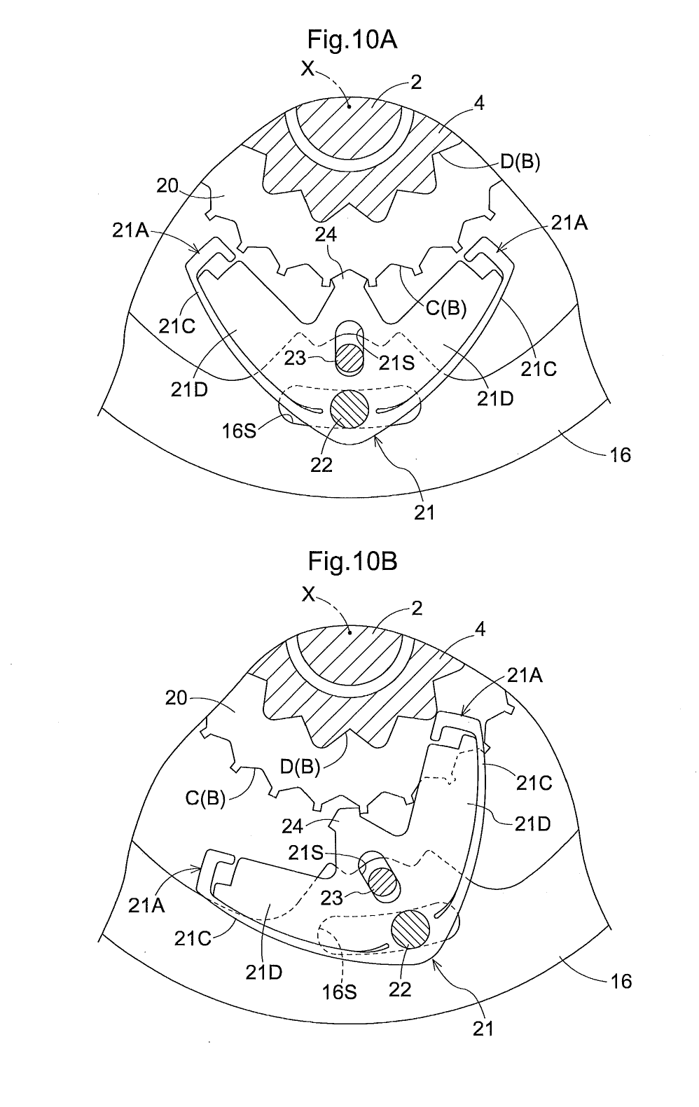

To address this issue, in another embodiment (a), each of the operating members 21 is configured so that when a contact piece 21A comes into contact with a lock portion D, the contact piece 21A can elastically deform under a reaction force from that lock portion in a state in which the contact piece 21A has mounted on a gear-like portion of the lock portion D. As shown in FIGS. 8 and 9, each operating member 21 is formed of a plate-like material and has an engagement protrusion 24 (an example of the engagement piece) that engages with an engagement portion C and a pair of contact pieces 21A that come into contact with the above-described lock portions D in the form of an external gear.

In the operating member 21, deforming portions 21C on an outer circumferential side extend from the vicinity of the pivotal support shaft 22 to the respective ends of the operating member 21 and are partially separated from respective main body portions 21D on an inner circumferential side, and the contact pieces 21A are provided at respective end portions of the deforming portions 21C. That is to say, each deforming portion 21C is connected to the main body portion 21D and the contact piece 21A. Each contact piece 21A is L-shaped so as to cover the main body portion 21D at a distance from an end portion of the main body portion 21D, and includes an end edge portion 21Aa serving as an end portion of the operating member 21, and an inner edge portion 21Ab extending from the end edge portion 21Aa toward the main body portion 21D. A protruding touching portion 21E that can touch the end edge portion 21Aa of the contact piece 21A is formed in the end portion of the main body portion 21D. The deforming portion 21C is made of spring steel or the like so as to be elastically deformable. When the contact piece 21A moves backward under a reaction force from the lock portion D in a state in which it has mounted on the gear-like portion of the lock portion D, the deforming portion 21C continues elastically deforming until the contact piece 21A touches the touching portion 21E, and returns to its original shape when the reaction force from the lock portion D is no longer applied to the contact piece 21A.

### [Form of Operation]

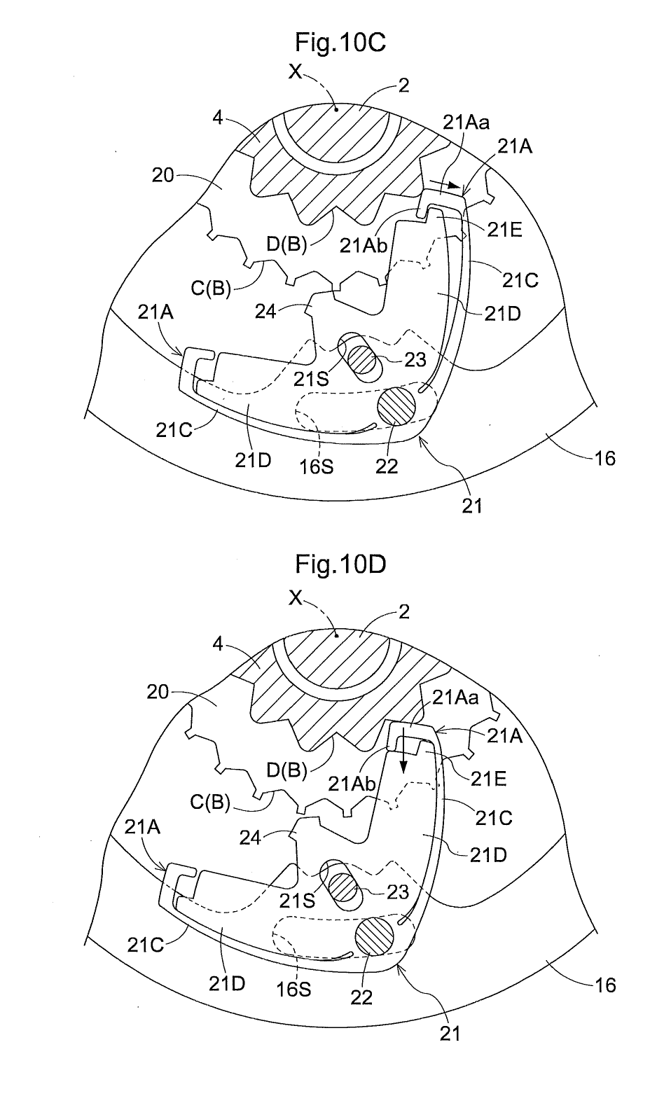

With this configuration, first, if the load acting on the output shaft 2 is less than a set value, the biasing force of the coil springs 17 maintains the relative rotational orientations of the operating ring 16 and the ring gear 12 in the neutral orientations, and in accordance with this, the operating members 21 are maintained in high-speed transmission orientations shown in FIGS. 8 and 10A.

In the high-speed transmission orientations, the engagement protrusion 24 of each operating member 21 is engaged with any of the plurality of engagement portions C formed along the outer circumference of the engagement plate 20. Thus, the ring gear 12 and the carrier 14 are combined with each other, and consequently a high-speed transmission state is realized in which the sun gear 11, the ring gear 12, the planet gears 13, and the carrier 14 are integrally rotated.

On the other hand, if the load acting on the output shaft 2 exceeds the set value, the relative rotational orientations of the operating ring 16 and the ring gear 12 come off the neutral orientations against the biasing force of the coil springs 17.

At this time, at a stage in the midst of gear shifting shown in FIG. 10B, respective forces of the contact state in which the engagement protrusion 24 of the operating member 21 is in contact with the engagement portion C and the contact state in which a contact piece 21A of the operating member 21 is in contact with a lock portion D (a state in which they begin to mesh with each other) are evenly matched, and there is a possibility that a so-called “deadlock” may be created. However, in the embodiment (a), when the reaction force from the lock portion D is applied to the contact piece 21A of the operating member 21, as shown in FIG. 10C, the contact piece 21A moves backward in the direction indicated by the arrow in a state in which it has mounted on the gear-like portion of the lock portion D, and the deforming portion 21C continues elastically deforming until the contact piece 21A touches the touching portion 21E. In the operating member 21, the contact piece 21A is provided in the end portion of the deforming portion 21C at a distance from the main body portion 21D, and therefore when the reaction force from the lock portion D is applied to the contact piece 21A, the contact piece 21A can move backward without being obstructed by the main body portion 21D.

When the contact piece 21A has moved backward, the main body portion 21D of the operating member 21 is allowed to rotate in a direction in which the engagement protrusion 24 disengages from the engagement portion C by a distance corresponding to the backward movement of the contact piece 21A. As a result, as shown in FIG. 10D, the engagement protrusion 24 of the operating member 21 first disengages from the engagement portion C, power transmission from the engagement plate 20 to the operating ring 16 is cut off, and then, while the elastically deformed deforming portion 21C is returned to the original state, the contact piece 21A completely meshes with the lock portion D.

Thus, it is possible to avoid a problem in that the operating member 21 in the contact state is deadlocked between the engagement portion C and the lock portion D. At the stage in the midst of gear shifting shown in FIG. 10B, meshing between the lock portion D and the contact piece 21A has already started, and as described above, even if it is set so that the engagement protrusion 24 disengages from the engagement portion C first and meshing between the lock portion D and the contact piece 21A is completed afterward, an “idling” state does not occur.

Moreover, the operating member 21 is configured so that in the state in which the contact piece 21A and the lock portion D completely mesh with each other, the reaction force of the lock portion D is applied to the end edge portion 21Aa of the contact piece 21A, causing the deforming portion 21C, which is continuous with the contact piece 21A, to elastically deform. Thus, in the operating member 21, the inner edge portion 21Ab of the contact piece 21A touches an end portion of the main body portion 21C, and the meshing state of the contact piece 21A and the lock portion D is maintained, so that the operating member 21 is stably set in the low-speed transmission orientation.

As described above, the contact piece 21A includes the end edge portion 21Aa and the inner edge portion 21Ab extending from the end edge portion 21Aa toward the main body portion 21D, and thus the operating member 21 can accept both the reaction force from the lock portion D in the state in which it is in contact with both of the engagement portion C and the lock portion D and the reaction force from the lock portion D in the low-speed transmission state. Moreover, the touching portion 21E is provided in the end portion of the main body portion 21D, and thus the deforming portion 21C of the operating member 21 is allowed to elastically deform until the contact piece 21A touches the touching portion 21E, and does not elastically deform after the contact piece 21A has touched the touching portion 21E. As a result, excessive deformation of the deforming portion 21C can be easily prevented, and the durability of the operating member 21 can be improved.

Furthermore, the operating member 21 is configured so as to be elastically deformable when the reaction force from the lock portion D is applied thereto, and thus, under a high load, gear shifting for a higher torque is performed preferentially, which enables reliable output. The elastically deformable deforming portions 21C are provided on both sides of the center of rotation of the operating member 21, and therefore the above-described effects can be obtained in both the left and right rotation directions.

### Another Embodiment (b)

In the operating members 21, it is not necessarily required that the deforming portion 21C and the main body portion 21D are separately provided, and these portions may also be integral with each other. In addition, a configuration may be adopted in which the contact piece 21A itself has elasticity so as to be deformable under the reaction force from the lock portion D.

### Another Embodiment (c)

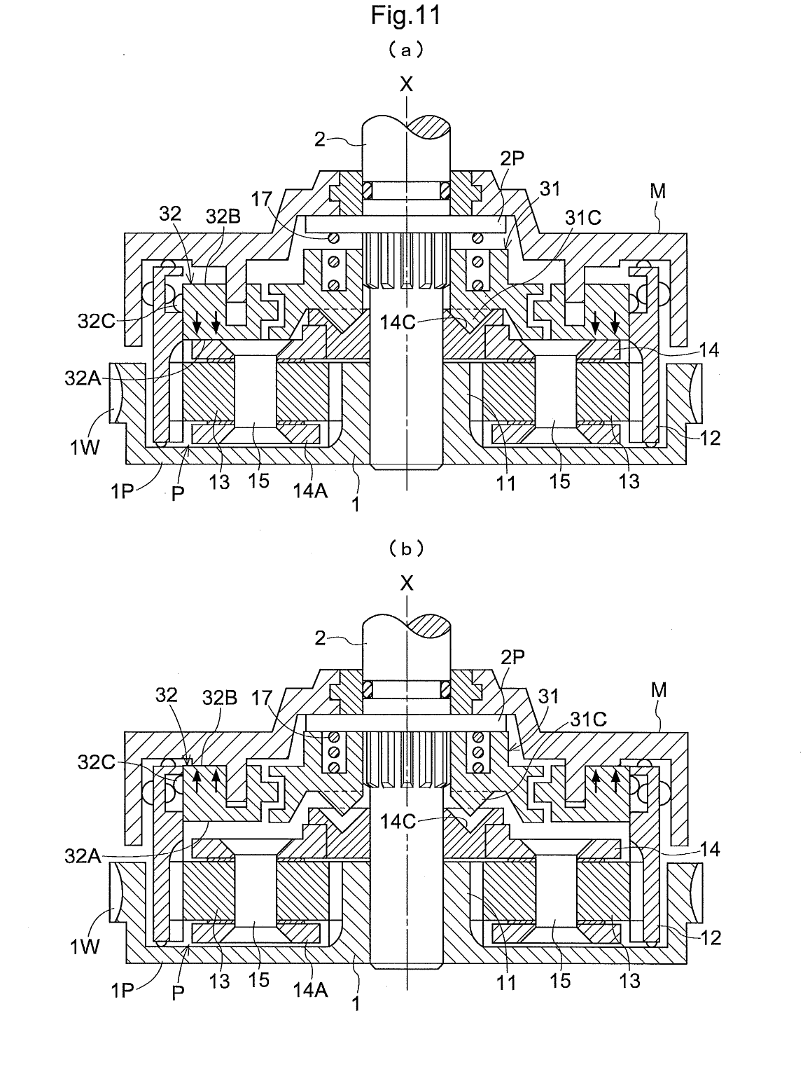

As shown in FIG. 11, a load-sensitive gear shifting apparatus according to another embodiment (c) includes a spindle-like output shaft 2, a tube-like input shaft 1 that is externally fitted to a lower end portion of this output shaft 2 so as to be rotatable, a planetary gear shifting mechanism P, and a transmission case M that is disposed in a position at which it covers these components. A plate 1P is coupled to a lower end of the input shaft 1, a worm gear 1W is provided at an outer circumferential portion of this plate 1P, and a driving force from an electric motor or the like is transmitted to this worm gear 1W. Although this load-sensitive gear shifting apparatus can be used in any orientation, the configuration of this apparatus will be described according to a vertical relationship shown in FIG. 11.

Also in this embodiment, if the load acting on the output shaft 2 is less than a set value, the output shaft 2 is driven in a high-speed transmission state in which the speed of the output shaft 2 is equal to the rotation speed of the input shaft 1. Moreover, if the load acting on the output shaft 2 exceeds the set value, a speed reduction is performed in the planetary gear shifting mechanism P, and thus the output shaft 2 is driven in a low-speed transmission state in which the speed of the output shaft 2 is lower than the rotation speed of the input shaft 1.

The planetary gear shifting mechanism P includes a sun gear 11 that is integrally formed with the input shaft 1, a ring gear 12 that is disposed in a position surrounding the sun gear 11, a plurality of planet gears 13 that interlock with the sun gear 11 and the ring gear 12, and a carrier 14 that can revolve together with the plurality of planet gears 13. The carrier 14 is provided with a plurality of freely rotating shafts 15 that supports the three planet gears 13 in a freely rotatable manner, and a carrier ring 14A that is coupled to respective end portions of the plurality of freely rotating shafts 15.

The input shaft 1 and the output shaft 2 are arranged coaxially with the main axis X, and the axis of the sun gear 11, the axis of the ring gear 12 (the axis at the center of the ring), and the axis of revolution of the carrier 14 are arranged coaxially with the main axis X.

A cam ring 31 is provided which is splined to the output shaft 2, and the cam ring 31 is disposed in a positional relationship in which a cam portion 31C formed in this cam ring 31 and a cam portion 14C formed in the carrier 14 come into contact with each other. The output shaft 2 is provided with a flange-like support plate 2P, and a biasing force for bringing the cam portions 31C and 14C into contact with each other is obtained by providing compression-type coil springs 17 (an example of a biasing member) between the support plate 2P and the cam ring 31. The cam portion 31C of the cam ring 31 and the cam portion 14C of the carrier 14 have respective shapes that cause the cam ring 31 to be displaced upward irrespective of the direction in which the output shaft 2 and the input shaft 1 are rotationally displaced relative to each other on the main axis X.

A shift ring 32 is provided which operates along the main axis X in accordance with the displacement of the cam ring 31 in the direction of the main axis X. A first contact portion 32A that comes into contact with the carrier 14 is formed at a lower surface of the shift ring 32, a second contact portion 32B that comes into contact with an inner surface of the transmission case M is formed at an upper surface of the shift ring 32, and a third contact portion 32C that comes into contact with the ring gear 12 is formed at the position of an outer end of the shift ring 32.

With this configuration, if the load acting on the output shaft 2 is less than a set value, as shown in FIG. 11(a), the cam ring 31 is in a reference position, and in accordance with this, the shift ring 32 is in a high-speed transmission position. When the shift ring 32 is in this high-speed transmission position, the first contact portion 32A comes into contact with an upper surface of the carrier 14. Moreover, if the load acting on the output shaft 2 exceeds the set value, relative rotational orientations of the carrier 14 and the cam ring 31 around the main axis X change, so that as shown in FIG. 11(b), the cam ring 31 reaches a shift position, and the shift ring 32 reaches a low-speed transmission position. When the shift ring 32 has reached this low-speed transmission position, the second contact portion 32B comes into contact with the inner surface of the transmission case M.

Furthermore, when the shift ring 32 is in the high-speed transmission position, the third contact portion 32C at the outer end thereof is in contact with the ring gear 12 and is combined with it, and the first contact portion 32A at the lower surface of the shift ring 32 comes into contact with the carrier 14, so that the high-speed transmission state is realized in which the entire planetary gear shifting mechanism P is integrally rotated and the input shaft 1 and the output shaft 2 are rotated at the same rotation speed.

Conversely, if the relative rotational orientations of the cam ring 31 and the carrier 14 around the main axis X change, as shown in FIG. 11(b), the cam ring 31 is spaced apart from the carrier 14. In accordance with this, the first contact portion 32A of the shift ring 32 is spaced apart from the carrier 14, and the second contact portion 32B comes into contact with the inner surface of the transmission case M, so that the low-speed transmission position is reached.

Moreover, when the shift ring 32 is in the low-speed transmission position, while the state in which the third contact portion 32C at the outer end thereof is in contact with the ring gear 12 is maintained, the first contact portion 32A at the lower surface of the shift ring 32 is spaced apart from the carrier 14, and the second contact portion 32B at the upper surface of the shift ring 32 newly comes into contact with the transmission case M and locks the rotation of the ring gear 12, so that the low-speed transmission state is realized in which rotation of the carrier 14 is allowed.

Then, in this low-speed transmission state, if the load acting on the output shaft 2 decreases, the biasing force of the coil springs 17 causes the cam ring 31 to return to the reference position and also the shift ring 32 to return to the high-speed transmission position. Thus, in the same manner as described above, the first contact portion 32A at the lower surface of the shift ring 32 comes into contact with the carrier 14, so that the high-speed transmission state is realized, in which the entire planetary gear shifting mechanism P is integrally rotated and the input shaft 1 and the output shaft 2 are rotated at the same rotation speed.

In this embodiment (c), the load obtaining means A is constituted by the cam ring 31, the cam portions 14C and 31C, and the coil springs 17. Moreover, the switching means B is constituted by the shift ring 32, the cam portions 14C and 31C, and the coil springs 17.

### Another Embodiment (d)

According to the present invention, a form of transmission may also be set in which the planetary gear shifting mechanism performs a speed reduction by transmitting the driving force of the input shaft to the ring gear and inhibiting rotation of the sun gear. The load obtaining means A may have the same configuration as that in the above-described embodiment. The switching means B has a configuration in which in the high-speed transmission state, the sun gear is allowed to freely rotate, and the ring gear and the carrier are coupled to each other and integrally rotated, while in the low-speed transmission state, the coupling between the ring gear and the carrier is cancelled, and rotation of the sun gear is inhibited.

With this configuration, if the load obtained by the load obtaining means A is less than a set value, the switching means B sets the sun gear to the freely rotating state and couples the ring gear and the carrier to each other and integrally rotates them, thereby realizing the high-speed transmission state. Moreover, if the load exceeds the set value, the switching means B cancels the coupling between the ring gear and the carrier and inhibits rotation of the sun gear, thereby realizing the low-speed transmission state by a speed reduction in the planetary gear shifting mechanism.

### Another Embodiment (e)

According to the present invention, the planetary gear shifting mechanism may also be a combination of a plurality of sets of planetary gear shifting systems. As an example, a planetary gear shifting mechanism can be envisaged which is configured so as to transmit a rotating force of a carrier of a planetary gear shifting system on an input side to a sun gear of a planetary gear shifting system at a next stage, thereby transmitting a significantly reduced rotation speed of the input shaft to the output shaft. A planetary gear shifting mechanism having this configuration can be provided with the switching means B that uses the operating members described in the above embodiment in all of the plurality of planetary gear shifting systems or in a part of the plurality of planetary gear shifting systems, and with such a configuration, a high-speed transmission state and a low-speed transmission state are realized.

### INDUSTRIAL APPLICABILITY

The present invention is applicable to any driving systems that operate a target object using a rotational driving force from an actuator. In particular, the present invention can be optimally used for a driving system in which a load varies during the operation of the target object.

1. A load-sensitive gear shifting apparatus, comprising:
a planetary gear transmission system constituted by a sun gear, a ring gear that surrounds the sun gear, a planet gear that interlocks with the sun gear and the ring gear, a carrier that can revolve together with the planet gear, and an output system that extracts the revolving motion of the carrier;
a load obtaining means that extracts the amount of a load acting on the output system as the amount of mechanical operation; and
a switching means that integrally rotates the sun gear, the ring gear, the planet gear, and the carrier if the load obtained by the load obtaining means is less than a set value, and allows rotation of the carrier while inhibiting rotation of any gear of the sun gear and the ring gear that is not a gear to which a driving force is input if the load obtained by the load obtaining means exceeds the set value.

2. The load-sensitive gear shifting apparatus according to claim 1, further comprising:
an input shaft that serves as an input system and transmits the driving force to the sun gear, and an output shaft that serves as the output system and is coupled to the carrier,
wherein the load obtaining means includes an operating ring that is supported coaxially with an axis of the ring gear so as to be rotatable relative to the ring gear, a biasing member that biases the operating ring and the ring gear so as to maintain their relative rotational orientations in neutral orientations, and an operating member that is linked with the carrier and the ring gear so as to change in orientation in accordance with a load acting on the carrier, the operating member being configured so as to be in a high-speed transmission orientation when the relative rotational orientations of the carrier and the ring gear are the neutral orientations, and reach a low-speed transmission orientation when the relative rotational orientations come off the neutral orientations.

3. The load-sensitive gear shifting apparatus according to claim 2,
wherein the switching means includes the operating member, an engagement portion that engages with the operating member to combine the operating member with the carrier when the operating member is in the high-speed transmission orientation, and a lock portion that comes into contact with the operating member to inhibit rotation of the ring gear when the operating member is in the low-speed transmission orientation.

4. The load-sensitive gear shifting apparatus according to claim 3,
wherein the operating member is supported by the ring gear so as to be swingable on a pivotal support shaft extending parallel to the input shaft and the output shaft, and includes an engagement piece that engages with the engagement portion and a contact piece that comes into contact with the lock portion,
a plurality of engagement portions each of which is said engagement portion is formed like a gear around an axis of the carrier, and
a plurality of lock portions each of which is said lock portion is formed on an inner surface of a gear case serving as a fixing system, like an external gear or an internal gear around the axis of the carrier.

5. The load-sensitive gear shifting apparatus according to claim 4,
wherein a circular arc-shaped long hole around the input shaft is formed in the operating ring so that the pivotal support shaft passes therethrough, a link shaft extending parallel to the input shaft passes through a long hole formed in the operating member, and the link shaft is coupled to the operating ring.

6. The load-sensitive gear shifting apparatus according to claim 4,
wherein the operating member is configured so that when the contact piece comes into contact with the lock portion, the contact piece can elastically deform under a reaction force from the lock portion in a state in which the contact piece has mounted on the gear-like portion.

7. The load-sensitive gear shifting apparatus according to claim 4,
wherein the operating member includes a main body portion, and a deforming portion that is connected to the main body portion and the contact piece, and is configured so that when the contact piece comes into contact with the lock portion, the deforming portion can elastically deform under a reaction force from the lock portion in a state in which the contact piece has mounted on the gear-like portion.

8. The load-sensitive gear shifting apparatus according to claim 7,
wherein in the operating member, the deforming portion on an outer circumferential side extends from the vicinity of the pivotal support shaft toward either end of the operating member and is partially separated from the main body portion on an inner circumferential side, and the deforming portion is connected to the main body portion and the contact piece by providing the contact piece at an end portion of the deforming portion.

9. The load-sensitive gear shifting apparatus according to claim 8,
wherein the contact piece is L-shaped so as to cover the main body portion at a distance from an end portion of the main body portion, and includes an end edge portion serving as an end portion of the operating member and an inner edge portion extending from the end edge portion toward the main body portion, and a protruding touching portion that can touch the end edge portion is formed in an end portion of the main body portion.

10. The load-sensitive gear shifting apparatus according to claim 1, comprising:
an input shaft that serves as an input system and transmits the driving force to the sun gear, and an output shaft that serves as the output system and is coaxial with an axis on which the carrier revolves,
wherein the load obtaining means includes a cam ring that can transmit a torque to the output shaft and can move along an axis of the output shaft, cam portions that are respectively formed in opposing surfaces of the cam ring and the carrier, and a biasing member that biases the cam ring toward the carrier, and is configured so that if the load acting on the output shaft is less than a set value, the cam ring is in a reference position, and if the load acting on the output shaft exceeds the set value, the cam ring reaches a shift position at a distance from the carrier, and
the switching means includes a shift ring that is, while maintaining a contact state in which the shift ring is in contact with the ring gear, located in a high-speed transmission position when the cam ring is in the reference position, and located in a low-speed transmission position when the cam ring is in the shift position, the shift ring including a first contact portion that comes into contact with the carrier, thereby integrally rotating the ring gear and the carrier, when the shift ring is in the high-speed transmission position, and a second contact portion that comes into contact with a fixing system, thereby inhibiting rotation of the ring gear, when the shift ring is in the low-speed transmission position.

11. The load-sensitive gear shifting apparatus according to claim 10,
wherein when the shift ring is in the high-speed transmission position, a third contact portion that is provided at an outer end of the shift ring comes into contact with and is combined with the ring gear, and the first contact portion of the shift ring comes into contact with the carrier, and thus a high-speed transmission state is realized in which the planetary gear transmission system is integrally rotated and the input shaft and the output shaft are rotated at the same rotation speed.

12. The load-sensitive gear shifting apparatus according to claim 10,
wherein when the shift ring is in the low-speed transmission position, while a state in which the third contact portion that is provided at an outer end of the shift ring is in contact with the ring gear is maintained, the first contact portion of the shift ring is spaced apart from the carrier, the second contact portion of the shift ring newly comes into contact with a transmission case and locks rotation of the ring gear, and thus a low-speed transmission state is realized in which rotation of the carrier is allowed.
